(19) United States
(12) Patent Application Publication
(10) Pub. No.: US 2025/0028585 A1
(43) Pub. Date: Jan. 23, 2025

(54) DETECTING WEBASSEMBLY-BASED BROWSER EXPLOITS

(71) Applicant: Palo Alto Networks, Inc., Santa Clara, CA (US)

(72) Inventors: Tao Yan, San Jose, CA (US); Edouard Amaury Bochin, Montréal (CA); Bo Qu, Saratoga, CA (US); Yu Fu, Los Gatos, CA (US)

(21) Appl. No.: 18/356,665

(22) Filed: Jul. 21, 2023

(51) Int. Cl. G06F 9/54

(52) U.S. Cl. CPC G06F 9/547

(57) ABSTRACT

An exploit detector hooks functions of a WebAssembly engine API that include functions invoked when creating a WebAssembly instance, when permissibly modifying read-write-execute (RWX) memory allocated for a WebAssembly instance, and when calling an exported WebAssembly function. Upon invocation of the hooked instance creation function(s), the detector obtains an address of RWX memory allocated for the instance, reads data stored there, and records an association between the address and the data. If the hooked function(s) for permissibly modifying RWX memory is invoked, the detector updates the data stored in the recorded association with the modified data read from the RWX memory. Based on invocation of the hooked function(s) associated with WebAssembly export function calls, the detector reads the current data in the RWX memory to be executed and compares this data to the data recorded in association with the address. If the actual and expected data differ, the detector detects a browser exploit.

### BACKGROUND

The disclosure generally relates to data processing (e.g., CPC subclass G06F) and to security arrangements for protecting computers, components thereof, programs, or data against unauthorized activity (e.g., CPC subclass G06F 21/00).

A browser exploit is an exploit that breaches security of a web browser, which is generally achieved by targeting a vulnerability or flaw of a web browser. Attackers gain access to a web browser of a remote system and consequently the remote system itself by way of a browser exploit.

Web Assembly is a portable binary code format that serves as a compilation target for a multitude of programming languages. Support for WebAssembly is widespread among major web browsers, thus allowing web applications to be written in high level languages other than the JavaScript® programming language. A WebAssembly instance object is an executable module that includes functions that can be accessed (e.g., called) from JavaScript code.

### BRIEF DESCRIPTION OF THE DRAWINGS

Embodiments of the disclosure may be better understood by referencing the accompanying drawings.

FIG. 1 is a conceptual diagram of detecting browser exploits that target WebAssembly.

FIG. 2 is a flowchart of example operations for inserting hooks for detecting WebAssembly-based browser exploits into target functions of a WebAssembly engine API.

FIG. 3 is a flowchart of example operations for detecting browser exploits based on monitoring contents of RWX memory allocated for a WebAssembly instance.

FIG. 4 depicts an example computer system with a browser exploit detector.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Executable WebAssembly code is usually executed from memory pages with read-write-execute (RWX) permissions that are allocated to WebAssembly instances. The allocation of RWX permissions to a WebAssembly instance, however, creates an opportunity for a browser exploit that can bypass data execution protection (DEP) security mitigation because the RWX memory from which WebAssembly code is executed cannot be marked non-executable with DEP. The exploit obtains the memory address of a WebAssembly instance and, by parsing the structure of the WebAssembly instance, determines the memory address of the RWX memory allocated to the instance. The shellcode is written to this RWX memory region and executed via calling an exported WebAssembly function for the instance.

Browser exploits that abuse the allocation of RWX memory for WebAssembly instances in this manner can be detected as described herein. An exploit detector is injected into a process of a web browser that uses a WebAssembly engine. The exploit detector inserts hooks into a plurality of functions of an API of the WebAssembly engine: a WebAssembly instance creation function(s), a memory content update function(s) by which the RWX memory allocated for the WebAssembly instance is permissibly modified, and a function invoked as part of executing exported WebAssembly functions. Upon invocation of a function by which a WebAssembly instance is created, a first of the inserted hooks is triggered, and the exploit detector can obtain the memory address of the RWX region allocated for the WebAssembly instance. The exploit detector reads data stored in memory at this address and records an association between the memory address and a copy of the data. If the function(s) by which the RWX memory is permissibly modified is invoked, a second of the inserted hooks is triggered. The exploit detector determines the modified data written to the RWX memory and updates the data that is recorded in association with the memory address accordingly. The recorded data thus reflects the content that is permissibly written to the RWX memory corresponding to the WebAssembly instance. Finally, invocation of a function that is called as part of preparing an exported WebAssembly function for execution triggers a third of the inserted hooks, based on which the exploit detector reads the data currently written to the RWX memory allocated to the WebAssembly instance and compares this data (the “actual” data) to the expected data that have been recorded in association with the memory address. If a difference between the actual and expected data written to the RWX memory is identified, the exploit detector detects an exploit that has abused the RWX memory of the WebAssembly instance and can prevent execution of the malicious code by blocking execution of the exported WebAssembly function. The exploit can be detected because the permissibly written contents of the RWX memory were monitored and recorded based on invocation of the hooks, so any differences are attributed to an exploit that writes to this memory region impermissibly.

### Example Illustrations

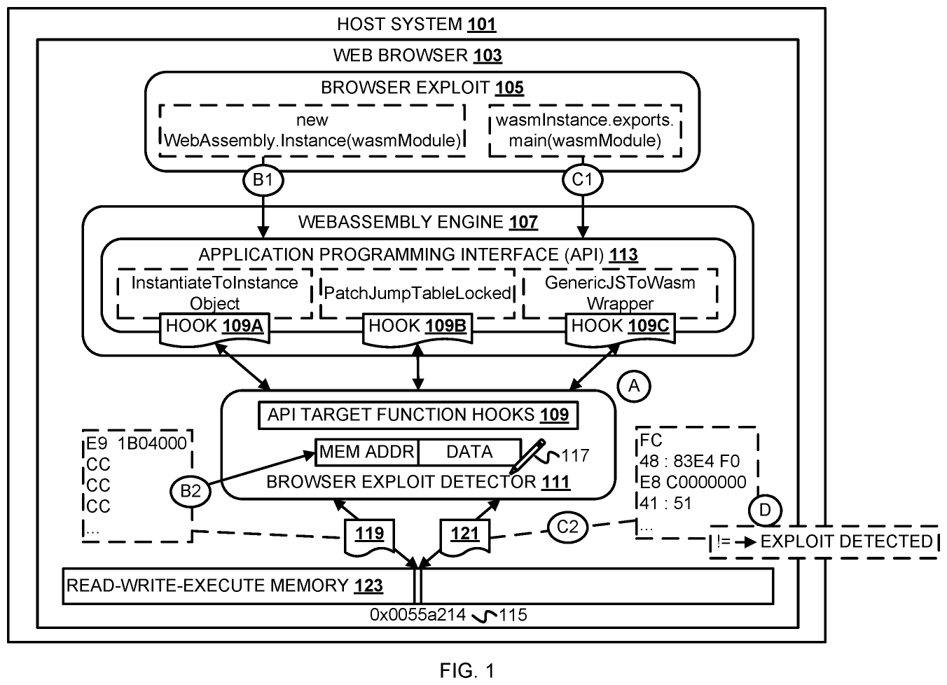

FIG. 1 is a conceptual diagram of detecting browser exploits that target WebAssembly. A web browser 103 executes on a host system 101. The web browser 103 is a web browser that supports WebAssembly. The web browser 103 uses a WebAssembly engine 107 to support execution of WebAssembly programs. The WebAssembly engine 107 may be a JavaScript and WebAssembly engine, such as the V8 JavaScript and WebAssembly engine. The WebAssembly engine 107 has an API 113, which may be an internal API of the WebAssembly engine 107. For implementations where the WebAssembly engine 107 is the V8 engine, the API 113 may correspond to the internal::wasm namespace of the V8 API. FIG. 1 also depicts a browser exploit detector 111. The browser exploit detector 111 has been injected into a process with which the web browser 103 is associated. To illustrate, the browser exploit detector 111 can comprise a dynamic link library (DLL) that is injected into the web browser 103 process via DLL injection.

FIG. 1 is annotated with a series of letters A-D. Each letter represents a stage of one or more operations. Although these stages are ordered for this example, the stages illustrate one example to aid in understanding this disclosure and should not be used to limit the claims. Subject matter falling within the scope of the claims can vary from what is illustrated. Additionally, FIG. 1 depicts stages B and C as comprising stages B1/B2 and C1/C2, respectively. This is to distinguish operations performed by the browser exploit detector 111 from other operations that trigger the operations performed by the browser exploit detector 111.

At stage A, the browser exploit detector 111 hooks into target functions of the API 113. The browser exploit detector 111 inserts hooks 109 (i.e., code hooks) into a set of target functions of the API 113 so that when the target functions are invoked, the corresponding hook is triggered, and execution redirects to the browser exploit detector 111. The browser exploit detector 111 hooks into three types of functions of the API 113: a function(s) invoked to create a WebAssembly instance, a function(s) invoked that results in permissible modification of the contents of memory allocated for a WebAssembly instance, and a function(s) invoked as part of executing exported functions corresponding to a WebAssembly instance. Naming of these functions can differ among WebAssembly engine APIs, though FIG. 1 depicts the API 113 as comprising functions associated with the V8 engine, with the hooks 109 comprising three respective hooks (depicted as hooks 109A-C). Hooked target functions can be functions of the API 113 that are invoked by the WebAssembly engine 107 as part of compiling a program to WebAssembly. In other words, the hooked target functions may not necessarily be called by a web application itself.

The browser exploit detector 111 inserts the hook 109A into a function of the API 113 named “InstantiateToInstanceObject,” which is a function that is invoked as part of creating a WebAssembly instance. The browser exploit detector 111 inserts the hook 109B into a function of the API 113 named “PatchJumpTableLocked,” which is a function that is invoked when patching a main jump table based on a change made to an exported WebAssembly function (e.g., based on optimization/deoptimization of an exported WebAssembly function) or other RWX memory allocated for a WebAssembly instance. The browser exploit detector 111 inserts the hook 109C into a function of the API 113 named “GenericJSToWasmWrapper,” which is a function that is invoked when a call to an exported WebAssembly function is made. Each of the hooks 109A-C may be inserted such that the hook is triggered upon invocation of the hooked function or before return of the hooked function.

At stage B1, invocation of a function by a browser exploit 105 to create a WebAssembly instance triggers the hook 109A. The browser exploit 105 executes in the web browser 103. The browser exploit 105 creates a new WebAssembly instance via calling the WebAssembly. Instance ( ) constructor for a WebAssembly module named “wasmModule.” The function “InstantiateToInstanceObject” of the API 113 should be invoked as part of creating the WebAssembly instance via the constructor call, which triggers the hook 109A and redirects execution to the browser exploit detector 111. The browser exploit detector 111 may have inserted the hook 109A such that it is triggered upon return of the “Instantiate ToInstanceObject” function.

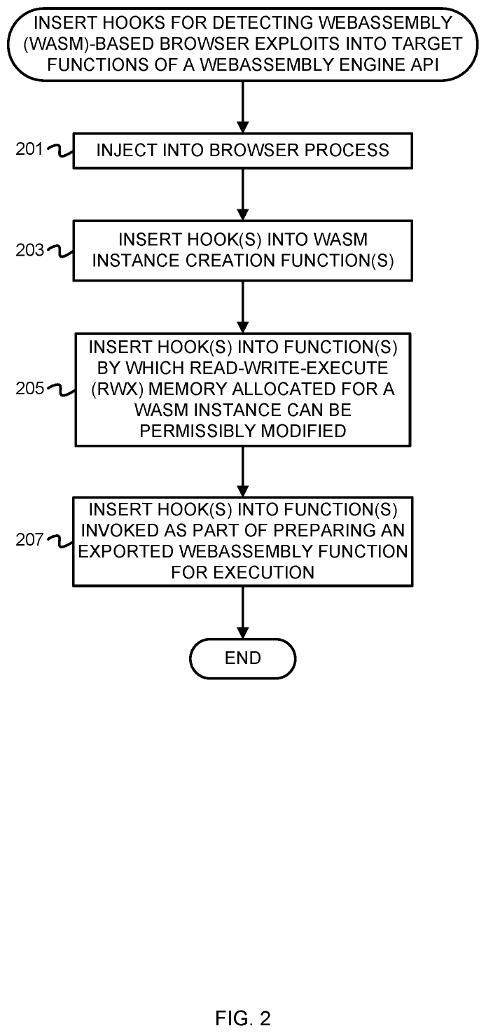

At stage B2, the browser exploit detector 111 determines a memory address of memory with RWX permissions (depicted in FIG. 2 as RWX memory 123) that is allocated for the created WebAssembly instance and contents of the RWX memory. The browser exploit detector 111 determines the address of the created WebAssembly instance based on a value returned from the “InstantiateToInstanceObject” function. Based on this address of the WebAssembly instance, the browser exploit detector 111 can determine the address of the RWX memory 123 allocated for the WebAssembly instance by accessing a property associated with the WebAssembly instance's address, where the property corresponds to this address (e.g., via WasmInstanceObject->main_jmp_table). FIG. 1 depicts the browser exploit detector 111 as identifying an address 115 of the RWX memory 123, depicted as 0x0055a214, as the address of the RWX memory 123 allocated for the WebAssembly instance created by the browser exploit 105. The browser exploit detector 111 reads contents 119 of the RWX memory 123 stored at the address 115 and records the address 115 and a copy of the contents 119 in a data structure 117 that it maintains. The data structure 117 comprises associations between addresses of RWX memory allocated for WebAssembly instances and the corresponding contents that are permissibly written to the RWX memory. Contents can be considered to be permissibly written if they are written via invocation of the API 113 rather than directly to the RWX memory 123, which will generally be by a malicious actor such as the browser exploit 105 that has gained access to the RWX memory 123.

At stage C1, a call to an exported function of the WebAssembly instance by the browser exploit 105 triggers the hook 109C. The browser exploit 105 calls an exported function of the WebAssembly instance named “main” via “wasmInstance.exports” to trigger execution of shellcode (not depicted in FIG. 1) written to the RWX memory 123. As part of executing an exported WebAssembly function, the function “GenericJSToWasm Wrapper” of the API 113 should be invoked, which triggers the hook 109C. The browser exploit detector 111 may have inserted the hook 109C to be triggered upon invocation of the “GenericJSToWasmWrapper” function (i.e., as opposed to return of the function) such that the hook is triggered before the exported function is executed.

At stage C2, the browser exploit detector 111 reads the contents of the RWX memory 123 corresponding to the created WebAssembly instance for which the exported function was called and compares the contents read from the RWX memory 123 with the memory contents stored in the data structure 117. To determine the address of the RWX memory 123 from which to read, the browser exploit detector 111 may determine the JSFunction parameter value obtained from the invocation of the “GenericJSToWasm Wrapper” function. The JSFunction parameter can be used to retrieve the WebAssembly instance associated with it and, from this WebAssembly instance, the RWX memory address can be obtained (e.g., via the path JSFunction->shared function info->function data->instance->RWX address). The browser exploit detector 111 reads contents 121 of the RWX memory 123 at this determined address and compares the contents 121 with those recorded in the data structure 117 (i.e., the contents 119). A difference between the contents written at the time of WebAssembly instance creation and the time of invocation of an exported function of the WebAssembly instance (i.e., the contents 119 and contents 121, respectively) can be attributed to a browser exploit attempting to execute code written to the RWX memory 123 of the WebAssembly instance it created. As depicted in FIG. 1, the contents 119 stored in the data structure 117 and the contents 121 read from the RWX memory 123 differ.

At stage D, the browser exploit detector 111 detects a browser exploit. The browser exploit detector 111 detects the browser exploit based on the determined difference between the contents permissibly written to the RWX memory 123 for the WebAssembly instance and those impermissibly written (i.e., those written by the browser exploit 105). The browser exploit detector 111 blocks execution of the exported function to prevent execution of malicious code written to the RWX memory 123 by the browser exploit 105. The browser exploit detector 111 can also generate a report or notification indicating that a browser exploit has been detected. The generated report or notification can comprise information about the exploit that the browser exploit detector 111 can discern, such as the affected memory address of the RWX memory 123. The browser exploit detector 111 can indicate the report or notification (e.g., via displaying on a graphical user interface GUI)), store the report or notification (e.g., in a database), etc.

While not depicted in FIG. 1, the hook 109B may be triggered based on invocation of the “PatchJumpTableLocked” function by the WebAssembly engine 107. The WebAssembly engine 107 may invoke this function based on recompiling the WebAssembly module and/or optimizing or deoptimizing an exported function of the WebAssembly instance. These operations result in modification of the RWX memory 123 allocated to the WebAssembly instance since the WebAssembly engine 107 will modify the main jump table to reflect the changes made to the code. When modifying the main jump table, the WebAssembly engine 107 calls the “PatchJumpTableLocked” function of the API 113, which triggers the hook 109B. The browser exploit detector 111 can thus read the contents of the RWX memory 123 that have been modified and update the contents recorded in association with the memory address of the RWX memory 123 in the data structure 117. This provides for monitoring the contents of the RWX memory 123 that have been permissibly written thereto, which prevents false positive detection of a browser exploit.

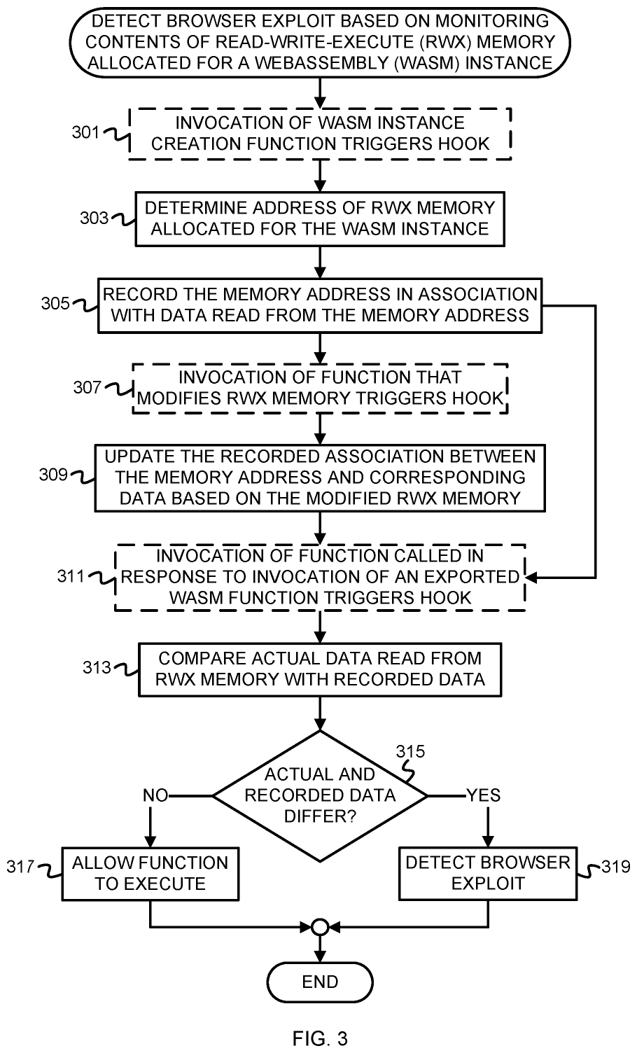

FIGS. 2-3 are flowcharts of example operations. The example operations are described with reference to a browser exploit detector for consistency with FIG. 1 and for ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for inserting hooks for detecting WebAssembly-based browser exploits into target functions of a WebAssembly engine API. The example operations assume that a process(es) has been launched for a web browser that supports WebAssembly with a WebAssembly engine. Functions of an API of the WebAssembly engine (e.g., an internal API of the WebAssembly engine) into which a hook should be inserted can be predefined per WebAssembly engine. Names of functions given below as examples are for implementations where the WebAssembly engine is the V8 JavaScript and WebAssembly engine, though names of functions to be hooked can vary among WebAssembly engines and corresponding APIs.

At block 201, the browser exploit detector is injected into the web browser process. Code units (e.g., one or more library(ies)) of the browser exploit detector are injected into the web browser process with a process injection technique. The particular technique for process injection may depend on the operating system of the host on which the web browser runs. For instance, the browser exploit detector may be implemented with a DLL that is injected into the browser process via DLL injection. The browser exploit detector may be self-injecting or may be injected via an injector program.

At block 203, the browser exploit detector inserts one or more hooks into a corresponding one or more functions of the API for creating WebAssembly instances. The function(s) that is hooked is one that accepts a parameter value(s) and/or returns a value(s) based on which the browser exploit detector can determine the memory address of RWX memory allocated for a WebAssembly instance. With reference to the V8 engine, the browser exploit detector can insert a hook into the function given by “v8::internal::wasm::InstantiateToInstanceObject.” The browser exploit detector can insert the hook(s) such that it is triggered upon return of the function (i.e., after a WebAssembly instance has been created).

At block 205, the browser exploit detector inserts one or more hooks into a corresponding one or more functions of the API by which RWX memory allocated for a WebAssembly instance can be permissibly modified. The function(s) that is hooked is one that is triggered when the WebAssembly engine modifies the RWX memory, such as via recompilation of a WebAssembly module and optimization/deoptimization of an exported WebAssembly function. These modifications to the RWX memory are considered permissible (i.e., as opposed to impermissible writes made by a browser exploit). With reference to the V8 engine, the browser exploit detector can insert a hook into the function given by “v8::internal::wasm::NativeModule::PatchJumpTableLocked.” The browser exploit detector can insert the hook(s) such that it is triggered upon return of the function (i.e., after the RWX memory has been modified by the WebAssembly engine).

At block 207, the browser exploit detector inserts one or more hooks into a corresponding one or more functions of the API that are invoked as part of executing an exported WebAssembly function. The browser exploit detector can insert the hook(s) such that it is triggered upon invocation of the function (i.e., before execution of the exported function). The function(s) to hook and technique for hooking can depend on the type and/or version of the web browser, which the browser exploit detector can determine (e.g., based on metadata of the web browser accessible to the browser exploit detector).

With reference to the V8 engine, for some web browsers, such as older versions of the Chrome® browser, the browser exploit detector can insert the hook into the function “Builtins_GenericJSToWasmWrapper” according to conventional code hooking techniques. For other web browsers in which the function “Builtins_GenericJSToWasmWrapper” is an inline function, such as newer versions of the Chrome browser, different approaches may be taken. As an example, the flag “--no-turbo-inline-js-wasm-calls” can be set when the web browser is launched. When this flag is used, the function “Builtins_GenericJSToWasm Wrapper” will not be an inline function, and the browser exploit detector can thus insert the hook into the function as described previously. As another example, the browser exploit detector can dynamically hook the “Builtins_GenericJSToWasm Wrapper” function. To do so, the browser exploit detector first determines the address of the inline “Builtins_GenericJSToWasm Wrapper” function. This can be achieved by inserting a hook into the function given by “v8::internal::WasmExportedFunction::New” that may be invoked during creation of a WebAssembly instance. This function accepts a parameter named “export_wrapper” associated with the exported function(s) of the WebAssembly instance. The browser exploit detector obtains the address of “Builtins_GenericJSToWasm Wrapper” via the value of the “export_wrapper” parameter that it obtains upon interception of the WebAssembly instance creation, such as by accessing a property of “export_wrapper” (e.g., via export_wrapper->entry_point). The browser exploit detector can then insert the hook for this determined address of the inline function.

Additionally, the wrapper of an exported function given by “Builtins_GenericJSToWasmWrapper” may be optimized for an export function. This results in the creation of a new wrapper given as “JSToWasmWrapper” for the export function and any export functions that share its signature. To determine the most recent address of an inline “JSToWasmWrapper” function of an exported WebAssembly function, the browser exploit detector inserts a hook into the function given by “v8::internal::(anonymous namespace)::Replace Wrapper.” When this hook is triggered, the browser exploit detector accesses the value of its parameter “wrapper_code” to determine an entry point property of the wrapper (e.g., via wrapper_code->entry_point) that corresponds to the inline function address. The browser exploit detector also inserts a hook into the wrapper with this determined address. As a result, a hook will be triggered upon invocation of any of the JSToWasm Wrapper functions, so the browser exploit detector can thus intercept a call to the API issued as part of preparing any exported function for execution, whether the exported function's wrapper has been optimized or not.

FIG. 3 is a flowchart of example operations for detecting browser exploits based on monitoring contents of RWX memory allocated for a WebAssembly instance. FIG. 3 depicts several blocks of example operations with dashed lines. This is to distinguish example operations corresponding to invocation of hooked functions that trigger redirection of the flow of execution to the browser exploit detector from example operations performed by the browser exploit detector itself.

At block 301, invocation of a WebAssembly instance creation function triggers a hook. The browser exploit detector intercepts the function invocation and can obtain a value(s) passed into the creation function as a parameter and/or returned from the WebAssembly instance creation function.

At block 303, the browser exploit detector determines an address of RWX memory allocated for the WebAssembly instance. The browser exploit detector can determine a memory address of the created WebAssembly instance that is returned from the WebAssembly instance creation function and obtained based on intercepting the function. From this memory address, the browser exploit detector can further determine the address of memory with RWX permissions that is allocated to the WebAssembly instance, such as based on determining an address of a main jump table via the Web Assembly instance's memory address.

At block 305, the browser exploit detector records the memory address in association with a copy of data read from that address. The browser exploit detector maintains a data structure (e.g., a map) in which it stores memory addresses of RWX memory and the corresponding data written to those addresses. The browser exploit detector reads data from the RWX memory at that memory address and stores the memory address and a copy of the data read from the RWX memory in a data structure (e.g., as a key-value pair in the map).

Block 305 is depicted as connecting to block 307 and block 311. Operations can continue at either block depending on the function that is next invoked to trigger a hook. In implementations, the WebAssembly engine may invoke a function(s) for permissible modification of the RWX memory, such as to optimize an exported function of the WebAssembly instance. If such a function is invoked, a corresponding hook is triggered, and operations continue at block 307. However, despite being hooked, this function(s) is not necessarily invoked across deployments of the browser exploit detector because the WebAssembly engine may not optimize/deoptimize an exported WebAssembly function or recompile a WebAssembly module and thus may not invoke the function(s). In other words, invocation of this function(s) may occur but is not a necessary part of WebAssembly compilation and execution. Operations continue at block 311 if the function(s) is not invoked.

At block 307, invocation of a function that modifies RWX memory triggers a hook. The browser exploit detector intercepts the function invocation and can obtain a value(s) passed into the function as a parameter and/or returned from the WebAssembly function.

At block 309, the browser exploit detector updates the recorded association between the memory address and the corresponding data based on the modified RWX memory. The browser exploit detector may read modified data from the memory address of the RWX memory that was recorded and update the association between the memory address and the corresponding data recorded in the data structure by replacing the data stored therein with a copy of the modified data (e.g., by replacing the value mapped by the memory address key with the copy of the modified data).

At block 311, invocation of a function that is called in response to invocation of an exported WebAssembly function triggers a hook. The browser exploit detector intercepts the function invocation and can obtain a value(s) passed into the function as a parameter and/or returned from the WebAssembly function.

At block 313, the browser exploit detector compares actual data read from the RWX memory with the recorded data. The browser exploit detector reads data from the memory address of the RWX memory allocated for the WebAssembly instance that was recorded at block 305. The browser exploit detector compares the data stored in the data structure corresponding to the WebAssembly instance with the current data read from the RWX memory allocated to the WebAssembly instance when the WebAssembly export function is called. This can be considered a comparison between actual data, or the data actually written to the RWX memory, and expected data, or the data stored in the data structure that indicates data permissibly written to the RWX memory.

At block 315, the browser exploit detector determines if the actual data and recorded data differ. The browser exploit detector determines that the actual data and the recorded or expected data differ if the data read from the RWX memory of the Web Assembly instance differs from the data recorded in the data structure for the Web Assembly instance. If the actual data and the recorded data are the same, operations continue at block 317. If the actual data and the recorded/expected data differ, operations continue at block 319.

At block 317, the browser exploit detector allows the function to execute. If the actual data stored in memory and the recorded data expected to be stored in memory are the same, the browser exploit detector allows execution of the invoked function and thus execution of the exported WebAssembly function for which the hook was triggered.

At block 319, the browser exploit detector detects a browser exploit. A difference between the actual data and the recorded/expected data is indicative of a browser exploit that has impermissibly written data to the RWX memory of the WebAssembly instance that it is attempting to execute via invocation of an exported WebAssembly function. The browser exploit detector blocks the execution of the hooked function that was invoked in response to the call to the exported WebAssembly function. The browser exploit detector may also indicate that a browser exploit was detected, such as via generation of a report or notification that is displayed on a GUI and/or stored for subsequent access.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 203, 205, and 207 of FIG. 2 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

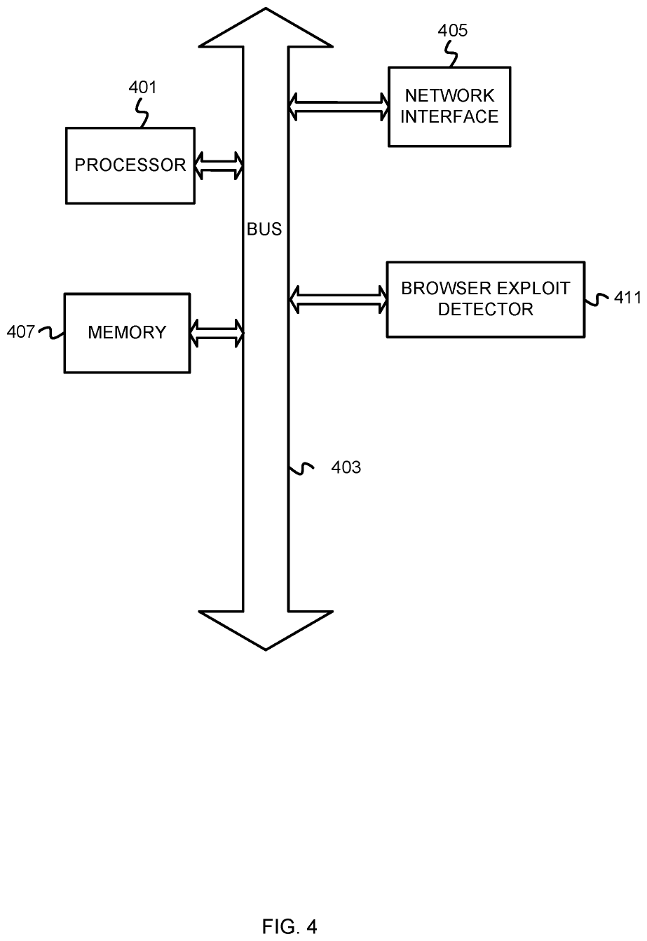

FIG. 4 depicts an example computer system with a browser exploit detector. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes browser exploit detector 411. The browser exploit detector 411 installs a plurality of hooks into a WebAssembly engine API to track contents permissibly written to RWX memory allocated for WebAssembly instances. The browser exploit detector 411 also detects browser exploits that abuse the allocation of RWX memory for WebAssembly instances based on differences in tracked, permissibly written contents of RWX memory and actual contents of the memory that are attributable to an exploit. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
installing a plurality of code hooks for a corresponding plurality of functions of an application programming interface (API) of a WebAssembly engine for a web browser;
based on invocation of a first function of the plurality of functions, determining an address of memory allocated for a WebAssembly instance and recording first contents read from the memory, wherein the memory has read-write-execute permissions;
based on invocation of a second function of the plurality of functions, reading second contents from the memory allocated to the WebAssembly instance;
determining if the first contents and the second contents of the memory differ; and
based on determining that the first contents and the second contents differ, determining that the web browser has been exploited.

2. The method of claim 1, wherein the first function is a function of the API for creating WebAssembly instances, wherein installing the plurality of code hooks comprises installing a first of the plurality of code hooks into the first function of the API.

3. The method of claim 2, wherein determining the address of memory comprises determining the address of memory based on a return value of the first function.

4. The method of claim 1, wherein the second function is a function of the API invoked based on calling exported functions of WebAssembly instances, wherein installing the plurality of code hooks comprises installing a second of the plurality of code hooks into the second function of the API.

5. The method of claim 1, wherein installing the plurality of code hooks comprises installing a third of the plurality of code hooks into a third function of the API, wherein the third function is a function of the API for permissibly modifying contents of the memory.

6. The method of claim 5 further comprising, based on invocation of the third function, reading third contents from the memory and updating the first contents recorded for the memory based on the third contents.

7. The method of claim 1, wherein recording the first contents read from memory comprises storing an association between the address of the memory and the first contents in a data structure.

8. The method of claim 1, further comprising injecting into a process associated with the web browser, wherein installing the plurality of code hooks is based on injecting into the process.

9. One or more non-transitory machine-readable media having program code stored thereon, the program code comprising instructions to:
hook into a plurality of target functions of an application programming interface (API) of a browser engine, wherein the browser engine is for a web browser with which WebAssembly is compatible;
based on invocation of a first target function of the plurality of target functions, determine a memory address of a first WebAssembly instance;
read first data stored at the memory address;
based on invocation of a second target function of the plurality of target functions, read second data stored at the memory address;
determine whether the first data and the second data differ; and
based on determining that the first data and the second data differ, detect an exploit targeting the web browser.

10. The non-transitory machine-readable media of claim 9 further comprising instructions to record a copy of the first data in association with the memory address.

11. The non-transitory machine-readable media of claim 10 wherein the instructions to hook into the plurality of target functions of the API comprise instructions to hook into a third target function of the API, wherein the third target function is a function for permissibly modifying memory allocated for a WebAssembly instance.

12. The non-transitory machine-readable media of claim 11, wherein the program code further comprises instructions to, based on invocation of the third target function, read third data stored at the memory address and replace the copy of the first data with a copy of the third data in the association with the memory address.

13. The non-transitory machine-readable media of claim 9, wherein the first target function is a function of the API for creating a WebAssembly instance, wherein the instructions to hook into the plurality of target functions comprise instructions to install a code hook to the first target function, wherein the instructions to determine the memory address of the first WebAssembly instance comprise instructions to determine the memory address based on a return value of the first target function.

14. The non-transitory machine-readable media of claim 9, wherein the second target function is a function of the API for invoked based on calling exported functions of a WebAssembly instance, wherein the instructions to hook into the plurality of target functions comprise instructions to install a code hook to the second target function.

15. An apparatus comprising:
a processor; and
a machine-readable medium having instructions stored thereon that are executable by the processor to cause the apparatus to,
install a plurality of code hooks into a corresponding plurality of functions of a WebAssembly engine application programming interface (API);
based on creation of a WebAssembly instance triggering a first of the plurality of code hooks, determine a memory address associated with read-write-execute (RWX) memory allocated for the WebAssembly instance;
record memory contents read from the memory address, wherein the memory contents have RWX permissions;
based on a call to an exported function of the WebAssembly instance triggering a second of the plurality of code hooks, compare current memory contents of the RWX memory with the recorded memory contents; and
based on a determination that the current memory contents and the recorded memory contents differ, detect a browser exploit.

16. The apparatus of claim 15, further comprising instructions executable by the processor to cause the apparatus to, based on modification of the memory contents triggering a third of the plurality of code hooks, update the recorded memory contents with modified memory contents read from the memory address, wherein the instructions executable by the processor to cause the apparatus to compare the current memory contents with the recorded memory contents comprise instructions executable by the processor to cause the apparatus to compare the current memory contents with the modified memory contents.

17. The apparatus of claim 15, wherein the instructions executable by the processor to cause the apparatus to record the memory contents comprise instructions executable by the processor to cause the apparatus to record the memory contents in association with the memory address in a data structure.

18. The apparatus of claim 15, wherein the instructions executable by the processor to cause the apparatus to install the plurality of code hooks comprise instructions executable by the processor to cause the apparatus to install the first code hook to a first function of the API, wherein the first function is a function for creation of WebAssembly instances, wherein the instructions executable by the processor to cause the apparatus to determine the memory address comprise instructions executable by the processor to cause the apparatus to determine the memory address based on a return value of the first function.

19. The apparatus of claim 15, wherein the instructions executable by the processor to cause the apparatus to install the plurality of code hooks comprise instructions executable by the processor to cause the apparatus to install the second code hook to a second function of the API, wherein the second function is a function invoked based on calling exported functions of WebAssembly instances.

20. The apparatus of claim 15, further comprising instructions executable by the processor to cause the apparatus to inject a library into a web browser process, wherein the instructions executable by the processor to cause the apparatus to install the plurality of code hooks comprise instructions executable by the processor to cause the apparatus to install the plurality of code hooks based on injection of the library into the web browser process.
